(19) United States
(12) Patent Application Publication
(10) Pub. No.: US 2005/0102156 A1
(43) Pub. Date: May 12, 2005

(54) System and method for managing information in a group participant purchasing environment

(75) Inventor: Kent Linduff, Boerne, TX (US)

Correspondence Address: COX SMITH MATTHEWS INCORPORATED, 112 EAST PECAN STREET, SUITE 1800, SAN ANTONIO, TX, 78205-1521, US

(73) Assignee: EBL TECHNOLOGY HOLDINGS, LTD.

(21) Appl. No.: 10/761,759

(22) Filed: Jan. 21, 2004

Related U.S. Application Data
(60) Provisional application No. 60/518,038, filed on Nov. 7, 2003.

(51) Int. Cl. G06F 17/60

(52) U.S. Cl. 705/1; 705/26

(57) ABSTRACT

Improved systems and methods for soliciting, acquiring and managing information associated with both buyers and sellers in a purchasing transaction. The system includes the computer hardware infrastructure necessary to allow specific input and management access to databases maintained by or through sellers of products and services, by the individual participants/purchasers of the products and services. The improved systems and methods permit paperless enrollment and information management into individual purchasing transactions and group purchasing transactions. The improved methods allow noncomputer literate individuals to readily understand, access and accurately manage information about themselves in association with an individual purchase transaction or an association with group purchasing transactions. The present invention finds particular application in such fields as employee benefit enrollment plans, group insurance plans and other types of goods and services purchasing transactions where significant amounts of information regarding the buyer might be required.

### RELATION TO PRIOR FILED APPLICATIONS

The present application claims the benefit of the filing date of U.S. Provisional Patent Application Ser. No. 60/518,038 filed Nov. 7, 2003.

### BACKGROUND OF THE INVENTION

1. Field of the Invention

The present invention relates generally to systems and methods for the management of information associated with individuals participating in the purchase and acquisition of goods and services. The present invention relates more specifically to systems and methods for the management of enrollment information associated with a participant in a group products and services purchasing environment.

2. Description of the Related Art

The purchasing of goods and services will frequently involve the exchange of significant amounts of information about both the buyer and seller, about the preferences and requirements of the buyer, and about the nature and character of the goods and services offered by the seller. Different purchasing environments require different levels of information exchange in order to effect a transaction. Some purchases require little more than name and address information and confirmation of payment to carry out the transaction. Other types of purchases require vast amounts of information, dictated by either the nature of the sale or by legal and administrative requirements placed on the sale by governmental authorities. The handling of this information, especially within certain types of transactions, can force significant additional costs to be incurred that ultimately must be absorbed by the buyer or seller in the transaction. There are, therefore, continuous efforts being made to make the exchange of information required to carry out a transaction more efficient.

Some efficiency in the provision of goods and services from sellers to buyers has been found in the establishment of group purchasing organizations. Such organizations can be very well defined group efforts such as employer sponsored health care plans, or loosely organized efforts such as coop purchasing programs. Group purchasing power is well known to provide participants with economies of scale not normally available to them when purchases are made individually.

Other efforts have been made to address the purchasing process for individuals who find it necessary to exchange information with sellers of various goods and services. In some instances it becomes even more important in the case of the individual purchaser to make the exchange of information required for the transaction very efficient. As an initial step in the management of information required to carry out a transaction, many sellers and/or group purchasers have established sets of forms designed to instill some level of consistency to a sequence of similar purchasing transactions. These forms try to identify certain informational elements or “fields” that through experience have been determined to be necessary for carrying out the transaction. While such form based systems have provided consistency to the information exchange process, they have in fact done little to improve its efficiency. The physical exchange of paper work in carrying out a purchasing transaction significantly slows the process and often deters the buyer and seller from engaging in the transaction.

A good example of a purchase involving the provision of goods and services that might be characterized by the exchange of significant amounts of information about both the buyer and the seller may be seen in employee benefits programs that are commonly established within businesses in the United States and elsewhere. Such employee benefits programs primarily include health care benefits in the form of insurance programs, retirement savings programs, life insurance programs and other forms of insurance, many of which may have specific tax implications for the employee. It is typical when bringing a new employee or participant into a group plan to require that significant amounts of information about the new participant or employee be acquired and maintained. Such information forms the basis for establishing the right of the participant to have access to the goods and services under the benefits plan as well as defining the pricing structure and the schedule of benefits available to that participant. This process can be seen as a “form intensive” process of acquiring information.

The employee benefits enrollment process has been migrating in recent times to computer based information acquisition and management and most recently to web based information acquisition and management. Initial efforts at automating the process of gathering and managing information on participants in a group plan have focused on the establishment and maintenance of data bases on computers that include all of the relevant information on the group plan participants. For the most part, however, this information continues to be input into the computer by one or more individuals assigned to such tasks after receiving the information from the employee/participant on paper forms. Thus, while the information may be readily accessible on the computer, the process of acquiring it from the participant and entering it into a data base is no more efficient than in the past. Likewise, the process of making any changes to this information often involves the use of forms on paper that must again be entered into the computer database by an individual assigned to such a task. These individuals assigned to input and manage this information are typically trained in the use of computers in order to make the process at least that much more efficient.

In the case of individuals seeking to make the purchase of various goods and services that require the acquisition and management of information, many will proceed with the transaction through the services of an agent or representative. The individual purchasing insurance, for example, has frequently been required to proceed through an agent because of the information intensive process of qualifying for and securing the products and services of insurance companies. The agent in this instance is one who happens to be trained and skilled in the specific forms and business rules associated with the goods and services being purchased. Here again, however, paper forms are typically involved in the transaction and the use of an agent provides consistency but does little to increase the efficiency of information management.

Another feature of employee benefit programs, again as an example of one type of purchasing transaction, is the lack of consistency between different businesses that provide the goods and services in the transaction. While the same informational elements may be required by two different insurance companies, as an example, it is seldom the case that the forms utilized by the insurance companies are identical or even similar in structure. The same can be said for computer software systems that have been developed by the individual sellers (insurance companies) or their agents for the purpose of managing the information received from the group participants. These software applications seldom are interchangeable and the movement of an individual or a group from one program or plan to another will typically involve the use of a new set of forms or a new software application for the purposes of inputting and managing the participant information. All of the above inefficiencies significantly add to the overall cost of providing the goods and services in the transaction contemplated These inefficiencies make it difficult not only to enroll new participants in group plans or in new transactions but also to update and manage information about existing participants as that information necessarily changes over time.

Higher efficiency would result where the individual or group participant is able to deliver and manage information about themselves and their interests in the contemplated transaction directly into the seller's database. Unfortunately, most current software based systems, both stand alone and network systems, are less than user friendly and typically require some significant level of skill in both the use of computers and more specifically in the delivery of information through computer generated on-screen forms and the like. It is only with great difficulty, therefore, that an individual purchaser, either directly or through a group, can access, input and manage information about themselves in a database from which the seller can acquire and maintain the information necessary to carry out the transaction.

### SUMMARY OF THE INVENTION

It is therefore an object of the present invention to provide systems and methods that permit the enrollment and management of information by an individual associated with a transactional purchase of goods and services.

It is a further object of the present invention to improve the efficiency of the entry of information about an individual relevant to the purchase of goods and services either directly or within a group purchasing environment.

It is a further object of the present invention to provide improved efficiency to the process of managing information in an existing database associated with individual participants in a group purchasing environment.

It is a further object of the present invention to provide methods and systems for improving the efficiency of the input and exchange of information associated with an individual establishing and complying with the requirements for carrying out a transaction directly with a seller of goods and services.

It is a further object of the present invention to provide improved systems and methods for enrolling individuals in group purchasing plans and managing the information associated with those individuals related to the purchasing transactions.

It is a further object of the present invention to provide improved information management systems that permit collaborative management between individuals providing the information as purchasers and individuals assisting the acquisition of the information by sellers of goods and services.

It is a further object of the present invention to provide methodologies for the management of information associated with group purchasing plans in a manner that facilitates the rapid dissemination of such information to targeted individuals within the group from the seller of goods and services.

In fulfillment of these and other objections, the present invention provides improved systems and methods for soliciting, acquiring and managing information associated with both buyers and sellers in a purchasing transaction. The system includes the computer hardware infrastructure necessary to allow specific input and management access to databases (maintained by or through sellers of products and services), by the individual participants/purchasers of the products and services. The improved systems and methods permit paperless enrollment and information management for individual purchasing transactions and group purchasing transactions. The improved methods allow non-computer literate individuals to readily understand, access, and accurately manage information about themselves in association with an individual purchase transaction or in association with group purchasing transactions. The present invention finds particular application in such fields as employee benefit enrollment plans, group insurance plans and other types of goods and services purchasing transactions where significant amounts of information regarding the buyer might be required.

### BRIEF DESCRIPTION OF THE DRAWINGS

FIG. 1 provides an overview of the systems associated with the present invention and required to carry out the methodologies.

FIG. 2 is a block diagram showing the system components required for adaptation of a legacy system into the system of the present invention.

FIG. 3 is a flowchart showing the method steps associated with an individual access routine in the methodology of the present invention.

FIG. 4 is a flowchart showing the method steps associated with an individual action routine in the methodology of the present invention.

FIG. 5 is a flowchart showing the method steps associated with a legacy system incorporation routine in the methodology of the present invention.

FIG. 6 is a flowchart showing the method steps associated with a collaboration routine in the methodology of the present invention.

### DETAILED DESCRIPTION OF A PREFERRED EMBODIMENT

The improved systems and methods of the present invention are broadly applicable to a number of fields of business where the exchange of information about buyers and sellers in a purchasing transaction requires efficient management. Much of the discussion that follows, however, focuses on the application of the improved systems and methods to the employee benefits industry as one example of a field where the exchange of information about buyers and sellers is required as part of the establishment and maintenance of the purchasing transaction. It should be understood by those skilled in the art that analogous applications of the present invention can be made to disparate fields of business where information regarding buyers and sellers may be required as a component of implementing and carrying out a purchasing transaction.

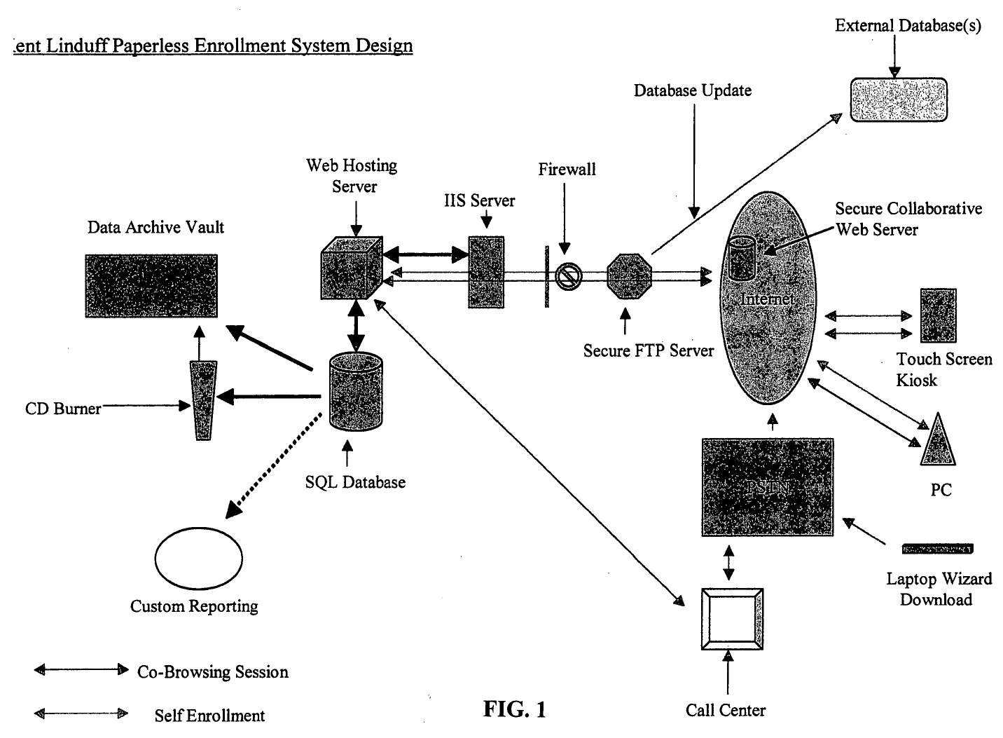

Reference is made first to FIG. 1 for a brief description of the computer and network structures required and implemented by the system of the present invention. In general, the system and method of the present invention take advantage of the Internet and other wide area network (WAN) structures to permit employee self enrollment and self management of a benefits package. High level structures implementing this system include a database, web hosting server, an IIS server, all behind a firewall. Outside the firewall a secure FTP server communicates with a secure collaborative web server and any external databases. Via the Internet, various end user structures communicate with the secure collaborative web server. End user structures include a call center, PC access, wireless device access, laptop wizard download, and touch screen kiosk based access. The laptop wizard download and the call center do not connect directly to the secure collaborative web server via the Internet; instead, they employ a public switched telephone network (PSTN) to interact with the Internet and ultimately to the secure collaborative web server. The call center may also interact directly with the web hosting server. Co-browsing employed throughout the system allows support technicians to guide employees who are unfamiliar with PCs through the paperless enrollment system. Low level structures include compression software for storing/transmitting images and a comma delimited text file for transmitting form data to and from legacy systems and/or the secure collaborative web server. Compression software in this case allows for efficiently transmitting, searching and retrieving forms stored as images. Transmitting text to a form data as comma delimited files eliminates the need for complicated electronic data interchange (EDI) components.

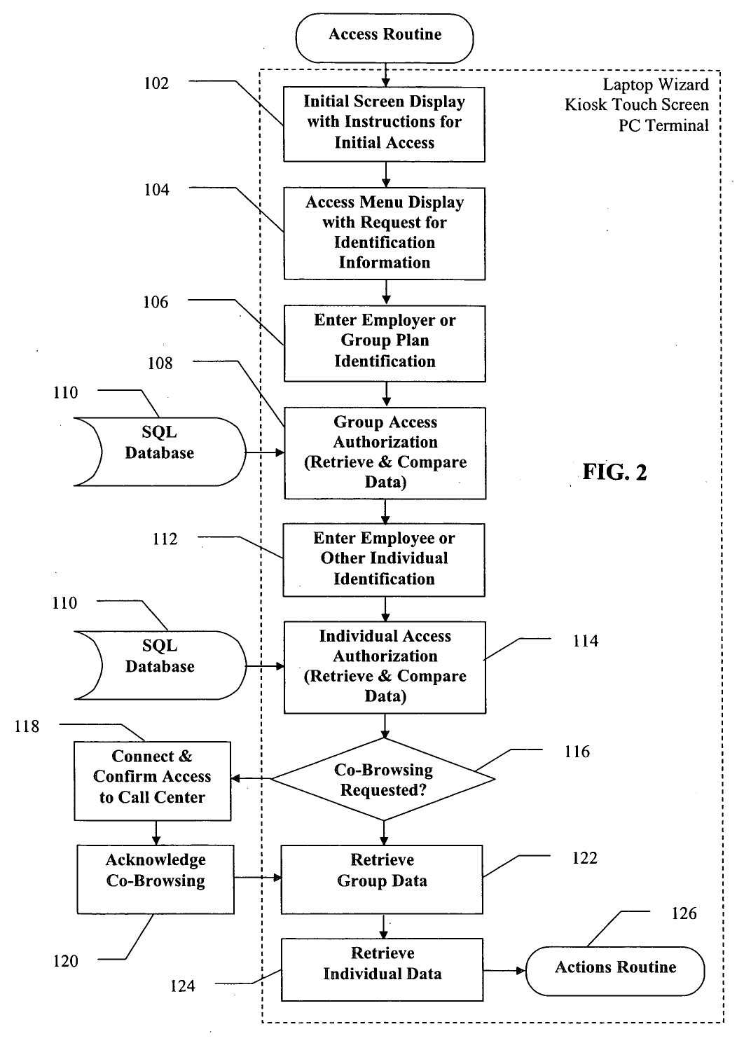

Reference is now made to FIG. 2 for a brief description of the specific architecture associated with the incorporation and adaptation of legacy systems into the database systems of the present invention. In FIG. 2 a range of individual users or user groups (A-N) have access to a current database to web interface or web enablement of the legacy system associated with the purchasing transaction. Most often this represents the existing software data management system utilized by a purchasing group or by a specific seller offering goods and services to individuals or to groups. The system of the present invention establishes access over the Internet to such current database to web interface or web enablement systems for the purpose of translating information contained therein into standard, accessible, readily manipulable data fields. This is accomplished through a comma delimited text data field secure front end environment that receives the database of the legacy system by way of the Internet and structures the same information into comma delimited text data fields appropriate for storage, access and management in the system of the present invention. A layer of interim data storage and secure transfer (or direct pass through to customer data sources) is provided beneath the translation system discussed above. Transfer of this interim data storage to specific employer or group data bases A-N may then be accomplished by way of network links indicated. The source of each of the systems identified in FIG. 2 is characterized as deriving from the enrollment services systems and software of the present invention (shown as bold bordered components) versus the customer (employer/employee) systems and software (shown as light bordered components).

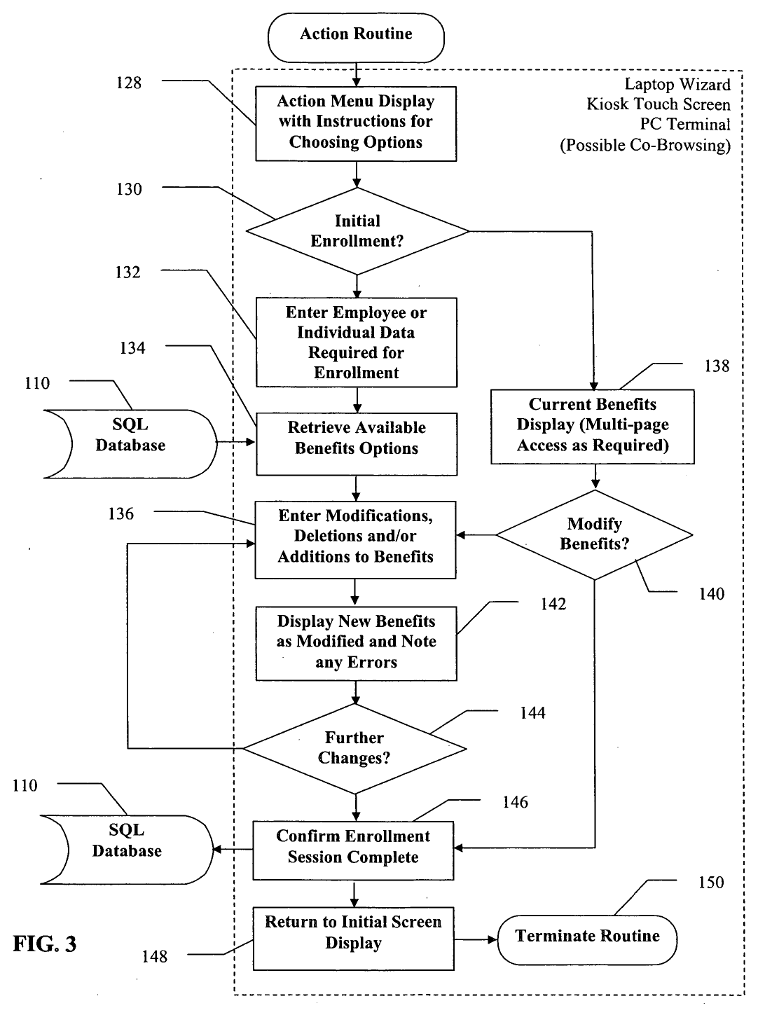

Reference is now made to FIGS. 3-5 which show algorithm flowcharts that describe various method routines associated with the overall methodology of the present invention. FIG. 3 describes the process whereby an individual user (an individual purchaser or an employee/participant in a group plan) accesses the database containing information associated with the individual as a purchaser of the products or services in the purchasing transaction. The access routine is initiated at step 102 with an initial screen display having instructions for initial access by the user. This is followed at step 104 wherein an access menu display is provided with a request to the user to submit identification information. Step 106 allows the user to enter employer or group plan identification so that the specific data base component can be identified. Step 108 involves group access authorization wherein group information is retrieved from SQL database 110 and compared to the information input by the user in step 106. Once group access authorization has occurred in step 108, the user proceeds at step 112 to enter employee or other individual identification information. Once again the process proceeds at step 114 to compare the input information with information retrieved from SQL database 110 so as to authorize individual access at step 114.

One feature of the present invention involves the incorporation of co-browsing or collaborative access and management for the purpose of facilitating use of the system by individuals not familiar either with computer database management or with the specific information requirements of the purchasing transaction. Step 116 therefore inquires as to whether co-browsing is being requested by the user. If so, the process proceeds at step 118 to connect and confirm access to a call center so that the user may be assisted within a co-browsing or collaborative session. Step 120 acknowledges to the user the establishment of the co-browsing session and then proceeds to step 122 wherein the group data information is retrieved. If co-browsing is not requested at step 116, then the process proceeds immediately to step 122 where group data is retrieved. Step 124 involves the retrieval of individual data that is to be utilized in the session. The access routine terminates and the user proceeds to actions routine 126.

It should be noted that all of the process steps carried out by the user may be implemented at any of a number of different hardware systems briefly described above with respect to FIGS. 1 and 2. Specifically, as is shown in FIG. 3, steps 102 through 126 may be carried out by the user by way of a laptop wizard, a kiosk touch screen computer, or a PC terminal directly available to the user either at home or at a place of employment. One beneficial aspect of the present invention is its ability to carry out the methodology described in association with any of these user access methods and to incorporate all of the co-browsing and collaborative features therein.

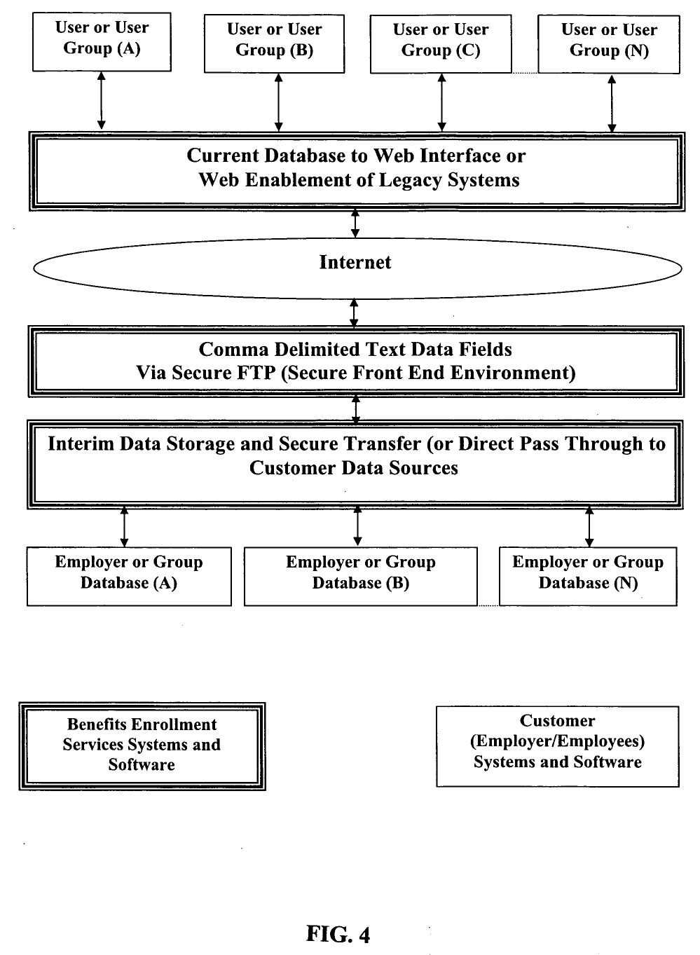

Reference is now made to FIG. 4 for a detailed description of the action routine associated with the methodology of the present invention. Following from access routine 126 shown in FIG. 3 the user, once having established individual access and having retrieved the appropriate sets of data, proceeds at step 128 where the user is when presented with an action menu display with instructions for choosing options associated with enrollment and management of the information. Step 130 asks the user whether this is an initial enrollment session or not. If the session is not associated with initial enrollment, the process proceeds to step 138 wherein the current benefits for the individual user are displayed. Multi-page access may be required depending upon the scope and extent of the information associated with the individual in the group purchasing plan.

If the session initiated by the user is an initial enrollment session, the process proceeds to step 132 wherein the user is prompted to enter employee or individual data as may be required for enrollment and defined by the administrator of the system. Step 134 involves the process of retrieving available benefits options from SQL database 110 that are predefined to be associated with the employee or individual user involved in the current session. The process then proceeds to step 136 wherein the user is permitted to enter modifications, deletions and/or additions to the benefits defined for that individual. Step 136 is also accessible where the session does not involve initial enrollment if, as queried at step 140, the user has accessed the system in order to modify benefits. In the event the session was initiated simply for the purpose of displaying existing or current benefits, the process may proceed from decision step 140 directly to step 146 wherein the process confirms enrollment session completion.

Returning to step 136 wherein the user is permitted to enter modifications, deletions and/or additions to the benefits, the process proceeds in step 142 to display the new benefits as modified with reference and notes to any errors that the system has detected in the information provided by the user. Step 144 queries whether further changes are required by the user which, if the user answers in the affirmative, the process returns to step 136 and allows the entry of modifications, deletions and/or additions. If at step 144 no further changes are required by the user, the process proceeds to step 146 wherein the system confirms the enrollment session completion. The modified data is then delivered to the SQL database 110 and the process proceeds to step 148 wherein a return to the initial screen display is presented to the user. Other appropriate termination routines 150 may be provided to verify the session or otherwise confirm to the user the success of access and management of information on the database.

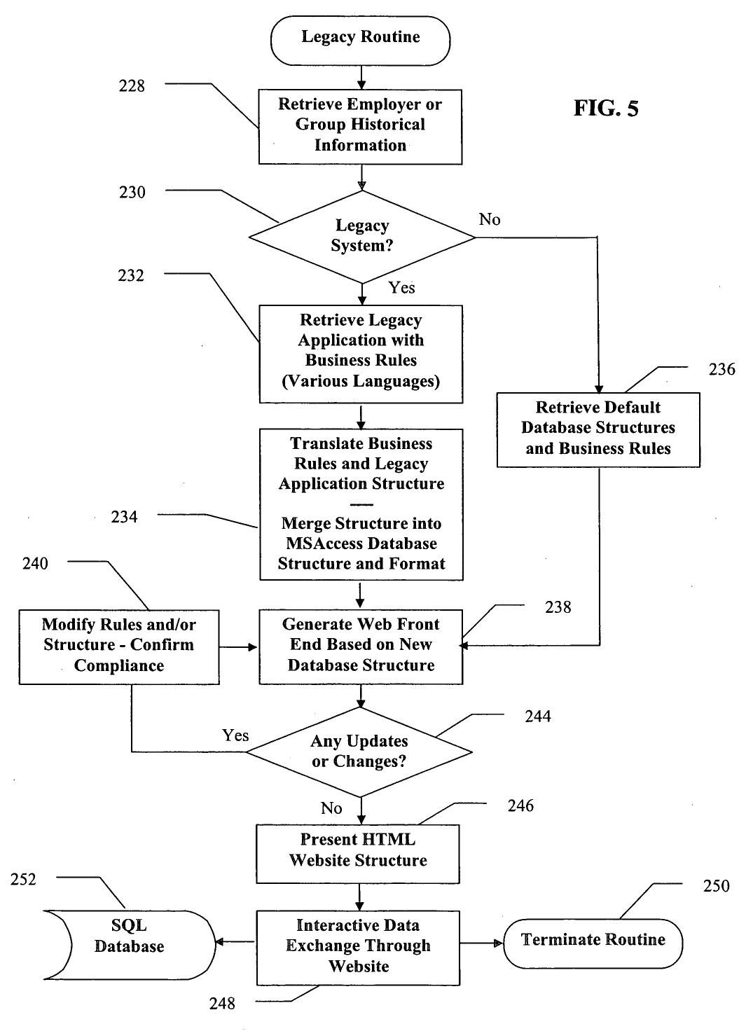

Reference is now made to FIG. 5 for a brief description of an additional methodology associated with the present invention that permits the incorporation of legacy information management routines into the “generic” system and structure of the present invention. The legacy routine in FIG. 5 begins at step 228 wherein the system retrieves employer or group historical information from an existing database. Step 230 queries whether the existing database, and the system that manages it, comprises a legacy system or not. If not, the process can immediately proceed to step 236 and retrieve a default database structure along with the associated default business rules that define access to the database. If the access is to a legacy system, the process proceeds at step 232 to retrieve the legacy application with the business rules associated with the system. Such legacy systems may comprise a variety of different languages and database management structures. Although a variety of such systems and structures exist, the range of possibilities is confined to but a few common database structures that are readily interpretable by well known means. The process proceeds at step 234 to translate the legacy business rules and legacy application structure and finally to merge the structure into a Microsoft® Access® database structure and format. Although Microsoft Access has been identified herein as a preferred database structure and format for implementation of the methods of the present invention, it should be understood by those skilled in the art that alternative and equivalent database structures and formats might be substituted without departing from the scope of the present invention. The importance is to establish a single consistent database structure and format that will allow the methodologies of the present invention to be carried out regardless of the source of the legacy system.

The process proceeds at step 238 wherein the system generates a web front end facility based on the new database structure. This web or Internet based front end is that interface intended to be presented both to the users (individual group participants or individual purchasers) and to the group plan administrators for the purpose of implementing the access and action routines described above and for implementing the collaborative development routines described below. Once the web front end has been established at step 238, the process proceeds to step 244 wherein the system queries the user whether any updates or changes are required. If so, the process proceeds at step 240 to receive modifications to the rules and/or structures and to confirm compliance with applicable system requirements.

It is, of course, anticipated that the process of updating and changing the rules and/or database structure would be limited to group plan administrators and would generally not be accessible to individuals who are accessing the system merely to enroll or update their personal profiles within the database. If, at step 244, no additional updates or changes are required, the process proceeds at step 246 to present a website page structure to both users and administrators of the system. At step 248 interactive data exchange through the website can now occur. This includes access to and from SQL database 252 as required. The routine is terminated at step 250 whereby translation of the legacy system has been effected into the operational system of the present invention.

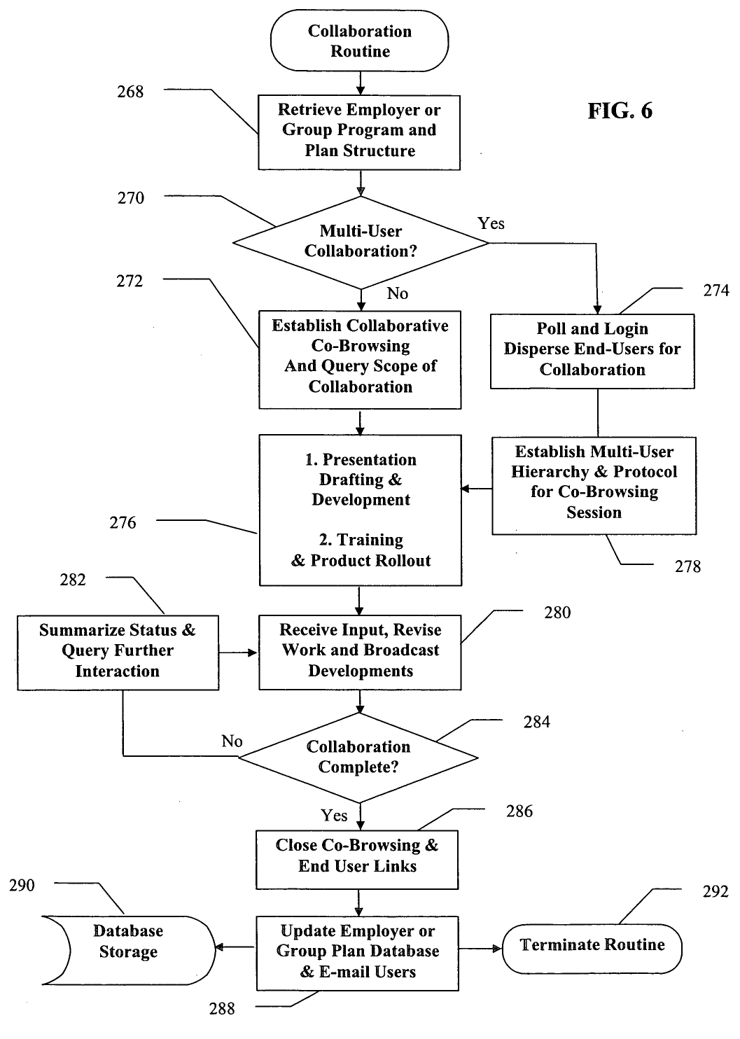

Reference is now made to FIG. 6 for a brief description of yet another feature of the methodology of the present invention that is facilitated by the above-described structure and database management approach. The collaboration routine shown in FIG. 6 provides for a variety of different types of interaction between system administrators and system users in the information management system described by the present invention. Step 268, shown in FIG. 6, initiates the collaboration routine by retrieving employer or group program and plan structure information. Essentially, all of the necessary information to carry out a collaborative effort is retrieved from the databases that define the group plan and individual participants in the plan. Step 270 queries whether this particular collaboration session involves multiple users. If so, step 274 in the process proceeds to poll and log-in any and all disperse end users necessary for participation in a collaboration. The process then proceeds at step 278 to establish a multi-user hierarchy and protocol for the co-browsing collaborative session.

If, at step 270, no multi-user collaboration is required, the process proceeds at step 272 to establish collaborative co-browsing between specific individuals and thereafter queries the scope of collaboration required. The collaboration routine might typically be incurred where a system administrator for a group plan requires the development of promotional or product informational materials that eventually will be disseminated to the participants in the group plan. The systems of the present invention, including the structural architecture described above with respect to FIGS. 1 and 2, permit an efficient interaction between individuals skilled in the development of such materials and those system administrators that are in the position to define the specifics of the materials required. Step 276 in FIG. 6 provides two examples, number 1 and 2 in the step, wherein the collaboration routine of the present invention might be applicable. The first of these is a presentation, drafting and development session, while the second is a training and product roll out session. In either case, the collaborative activities required for each are developed at step 276 with the goal of producing a product that is eventually presented to multiple users on either an individual or group basis. Step 280 in the process involves the receipt of input from the users in the collaborative session, the revision of the work that is the goal of the session, and the broadcast of developments to all users collaborating in the session. Step 284 queries whether the collaboration session is complete once the development had been broadcast to all the users at step 280. If not, process proceeds to step 282 wherein the status of the work product is summarized and a query is made with a further interaction and development from the user's is required. The process therefore proceeds again at step 280 to receive additional input, make additional revisions to the work and thereafter broadcast subsequent developments.

Once collaboration is completed at step 284, the process proceeds at step 286 to close the co-browsing and end user links in completion of the session. At step 288 the process updates the employer or group plan database with the results of the collaborative session and e-mails the appropriate users as notification or distribution of the work product. Database storage 290 maintains an updated record of the work product and the materials that result from the collaboration routine. The routine terminates at step 292 as indicated.

In summary, the critical components of the present invention are as follows:
1. Compression software as may be required with the capacity to compress three-dimensional forms significantly enough to provide for their efficient transport over networked connections;
2. System and software algorithms that provide the functional methodologies described above to implement the efficiencies of the invention;
3. Database form templates that allow business rules programming without the development of individual forms; and
4. End user interactive systems (laptop wizard, kiosk display, PC systems, etc.) that permit end users unfamiliar with computer based information management to access and utilize the systems.

The present invention anticipates that the above system and methods would be implemented in a number of end products. These would include self service web based access systems, self service systems with call center collaboration, self service systems with co-browsing call center collaboration, fully collaborative touch screen kiosk systems, and laptop wizard access systems.

The implementation of the invention described herein allows for flexibility in the definition and structure of the systems utilized in a particular instance. This permits groups or individuals utilizing the system to choose only the features and functionalities that are required at a cost significantly below that of premium priced custom developed solutions. Much of the initial upfront development costs are thereby eliminated.

The structures and methodologies defined above exist in an essentially paperless environment. Not only are existing legacy systems adapted to interface in the most cost effective manner, users of the system are able to interface the business systems seamlessly with little or no human intervention.

The system described is an interactive technology based solution with direct open architecture interfaces to call center technologies and existing legacy systems. As described, it encompasses full collaboration capability and allows for the above described paperless environment for non-computer literate users. The system includes methodologies that allow each of these technologies to interface in a cost effective manner with flexibility to deliver a custom solution that meets the specific business requirements of the group plan administrator or the purchase transaction seller. The interactive system established, initially as a basis for information enrollment and management, allows for a variety of additional activities to occur within the administration of the group plan or the purchasing transaction structure. These additional activities include such things as employee training, new product roll-out, remote troubleshooting and software distribution, customer access to required information, enrollment in a variety of services and products, and sales and marketing presentations.

An additional feature of the present invention includes customer support in the form of monitoring the enrollment web site and instantly initiating an on-line chat with an enrollee or customer that requests such support. This feature of the present invention may be viewed as distinct from the co-browsing techniques and methodologies described above in that questions are answered and assistance is obtained through written communication back and forth between the customer and the customer support representative. Support icons could be placed on any or all of the web pages associated with the enrollment services and/or the database management services. By clicking on a support icon the customer will prompt the initiation of a simple chat screen or window that allows communication with the customer support representative monitoring the web site. This additional methodology can be accessed from any of the screens presented to the user through any of the method steps discussed above. In the process, the customer service representative can be automatically alerted to the procedures that the customer or enrollee is then currently engaged with at the time customer service was requested. This versatility, as an adjunct to the co-browsing technologies and methodologies described above, makes the system of the present invention particularly easy to use, especially for those with little or no computer database experience or knowledge.

The system design allows existing legacy systems to interface in a cost effective manner, utilizing open architecture and in the methodologies described herein, users of the system are able to interface with very little if any human intervention in the process.

The standard interface in the present system is a comma-delimited file. The output file from the system, initially comprised of the comma-delimited fields, will contain the data captured during an enrollment process and will be presented in a predefined format. The customer carrier or other authorized individuals may then download this extract file to a secure FTP cite for retrieval as needed and as authorized. A similar interface is utilized to extract from a customer's business system the information necessary to populate the derived database with employee or plan participant details. It is in part the flexibility associated with the receipt of both data and business rules derived from legacy systems that allows the system of the present invention to efficiently benefit the participants and administrators of purchasing structures such as group health care plans and the like.

The methodologies provided by the present invention further incorporate user friendly features that allow individual users to enroll and manage the information associated with their purchasing transaction directly across the Internet, through a call center with agents that facilitate the enrollee or participant through the process and then follow-up with confirmation of the service, through a touch screen kiosk that can be used, for example, within an employer's facilities or elsewhere with public access, or finally through human resources personnel or an agent utilizing the laptop wizard described above that would assist in the acquisition and management of the data into the secure FTP cite.

1. A system for improving the management of information in a group participant purchasing environment having a legacy database and legacy processing software comprising:
a wide area network interface processor capable of accessing said legacy database and said legacy processing software, said interface processor for preparing said legacy database for transmission over a wide area network;
a secure front end processor for receiving, by secure FTP, said legacy database into comma delimited text data fields in a new database; and
an interim data storage and secure transfer processor for receiving said new database from said secure front-end processor and storing and transferring said new database to users in said group participant purchasing environment.

2. The system of claim 1 wherein said wide area network is the Internet.

3. The system of claim 1 wherein said legacy database and said new database comprise employee benefit enrollment information.

4. A method for managing information in a group participant purchasing environment, said management occurring with minimal paperwork and with ease of access by individuals inexperienced with computer based information management tools, the method comprising the steps of:
providing access processing for information and enrollment through a display device and an information input device;
providing action processing for modification of information associated with an enrolled individual in the group participant purchasing environment;
providing collaborative processing for including co-browsing capabilities for the modification of information and/or the development of new information in conjunction with an established database associated with said group participant purchasing environment; and
providing legacy processing for translating business rules and legacy application structure into a new structure suitable for use in conjunction with said access processing, said action processing, and said collaborative processing.

5. The method of claim 4 further comprising the step of providing user assistance processing during any of said access processing, action processing, collaborative processing, and legacy processing steps, said user assistance processing comprising the establishment of a communication link between the user and a customer service representative capable of answering questions and providing instructions to the user during the implementation of the method for managing information.

6. The method of claim 4 wherein said step of providing access processing comprises the steps of:
providing an initial screen display to a user with instructions for initial access;
requesting and receiving from the user group identification information associated with the group participant purchasing environment;
authorizing group data access by the user;
requesting and receiving employee and/or other individual identification information from the user;
authorizing individual data access by the user;
querying whether co-browsering is requested by the user;
if co-browsing is requested by the user, connecting and confirming access to a call center and acknowledging the establishment of co-browsing;
retrieving group data from a group participant purchasing environment database; and
retrieving individual data from said database.

7. The method of claim 4 wherein said step of providing action processing comprises the steps of:
providing an action menu display to the user with instructions for choosing actions;
querying whether the action processing session involves initial enrollment of the user;
if initial enrollment is not being requested, then displaying the current individual data associated with the user and querying whether the action processing session is intended to modify the current data;
if initial enrollment is requested by the user, requesting and receiving the employee or individual data required for enrollment;
retrieving from an SQL database the available benefits options for the user;
requesting and receiving modifications, deletions and/or additions to individual data from the user;
displaying the new individual data as modified and noting any errors resulting from inconsistencies with the available benefits options;
querying whether further changes are to be made by the user;
if further changes are indicated, repeating said steps of requesting and receiving modifications, deletions and/or additions and said step of displaying new individual data as modified;
confirming that the action processing is complete;
transferring modified data to said SQL database; and
returning to said step of providing an action menu display.

8. The method of claim 4 wherein said step of providing collaborative processing comprises the steps of:
retrieving group program and plan structure information;
querying whether multi-user collaboration is required;
if multi-user collaboration is required, polling and logging in disburse end users for collaboration and establishing multi-user hierarchy and protocol for co-browsing session;
if multi-user collaboration is not requested, establishing a one to one collaborative co-browsing session and querying the scope of collaboration;
carrying out a collaborative modification of data and/or development of data between users;
receiving input from the users and revising a data work product;
broadcasting to the users developments and modifications in said data work product;
querying whether collaborative processing is complete;
if collaborative processing is not complete, broadcasting the status, querying whether further interaction is required, and returning to said steps of receiving input, revising said data work product, and broadcasting developments and modifications;
if collaborative processing is complete, closing the co-browsing session and end user links;
updating an employer and/or group plan database with modified or developed data; and
emailing all users involved in said collaborative processing said updated employer and/or group plan database information.

9. The method of claim 4 wherein said step of providing legacy processing comprises the steps of:
retrieving group historical information from an initial database;
querying whether said initial database comprises a legacy system;
if said initial database does not comprise a legacy system, retrieving default database structures and business rules;
if said initial database comprises a legacy system, retrieving legacy application with business rules;
translating business rules and legacy application structure into a standardized database structure and format;
generating a wide area network front-end system based on said standardized database structure and format;
querying whether any updates or changes to said database are required;
if any updates and changes are required, modifying the rules and/or structure to confirm compliance and returning to said step of generating a wide area network front-end system;
if no updates or changes are required, presenting an HTML website structure on said wide area network; and
providing interactive data exchange through said website structure in connection with an SQL database.
